(19) United States
(12) Patent Application Publication
(10) Pub. No.: US 2019/0164311 A1
(43) Pub. Date: May 30, 2019

(54) VIEWING DIRECTION ESTIMATION DEVICE

(71) Applicant: AISIN SEIKI KABUSHIKI KAISHA, Kariya-shi (JP)

(72) Inventor: Shunsuke KOGURE, Kariya-shi, Aichi (JP)

(73) Assignee: AISIN SEIKI KABUSHIKI KAISHA, Kariya-shi (JP)

(21) Appl. No.: 16/309,525

(22) PCT Filed: Mar. 14, 2017
(86) PCT No.: PCT/JP2017/010227

§ 371 Date: Dec. 13, 2018

(30) Foreign Application Priority Data
Jun. 17, 2016 (JP) 2016-121219

(51) Int. Cl. G06T 7/73; G06T 7/246; G08G 1/16; B60W 40/09

(52) U.S. Cl. CPC G06T 7/75; B60W 40/09; G08G 1/16; G06T 7/251

(57) ABSTRACT

A viewing direction estimation device of an embodiment includes, for example: a storage that stores therein a transition probability between viewing directions of a driver of a vehicle; and a processor configured to: receive an observation value on a face or a visual line of the driver; update the transition probability from the viewing direction at a first time to the viewing direction at a second time later than the first time, based on the observation value at the first time and the observation value at the second time; calculate a state probability shifting from the viewing direction at the first time to the viewing direction at the second time according to the updated transition probability using a Hidden Markov Model; and estimate the viewing direction at a time after the second time, based on the calculated state probability.

### TECHNICAL FIELD

The present invention relates to a viewing direction estimation device.

### BACKGROUND ART

Conventionally, a technique for learning correspondence between the driving environmental risk of a moving body and a driving operation of a driver who is driving the moving body, and estimating the risk recognition state of the driver as the internal state by using a Hidden Markov Model (HMM) on the basis of the learning model, which is the learning result, has been known. Moreover, there is a technique for selecting gazing point data in which the driver of the vehicle is assumed to be gazing a specific object to be gazed, from the gazing point data indicating the position of the gazing point at which the driver is gazing; defining the range corresponding to the specific object to be gazed on the basis of the selected gazing point data; and determining that the driver is gazing the specific object to be gazed when the position indicated by the gazing point data is within the range.

### CITATION LIST

### Patent Literature

Patent Document 1: Japanese Patent Application Laid-open No. 2009-73465

Patent Document 2: Japanese Patent Application Laid-open No. 2015-85719

### SUMMARY OF INVENTION

### Problem to be Solved by the Invention

However, in the technique for estimating the risk recognition state of the driver using the Hidden Markov Model, the learning model significantly influences the state transition between the risk recognition states of the driver. Moreover, when the risk recognition state of the driver is changed frequently, the estimation of the risk recognition state of the driver may not be able to follow the change. Furthermore, although the technique for determining whether the driver is gazing the specific object to be gazed using the gazing point data is robust against the change in the object to be gazed, when there is an error in the gazing point data or when the error in the gazing point data is significantly changed by the external environment, accuracy in determining whether the driver is gazing the specific object to be gazed may be reduced.

### Means For Solving Problem

A viewing direction estimation device of an embodiment includes, for example: a storage that stores therein a transition probability between viewing directions of a driver of a vehicle; a receiver that receives an observation value relating to a face or a visual line of the driver of the vehicle; an update unit that updates the transition probability from the viewing direction at a first time to the viewing direction at a second time that is later than the first time, based on the observation value at the first time and the observation value at the second time; a calculator that calculates a state probability shifting from the viewing direction at the first time to the viewing direction at the second time according to the transition probability being updated, using a Hidden Markov Model; and an estimation unit that estimates the viewing direction at a time after the second time, based on the state probability being calculated. Consequently, for example, the estimation result of the viewing direction can follow the quick change in the viewing direction.

In the viewing direction estimation device of the embodiments, the update unit calculates a probability density function of a difference between the observation value at a third time that is earlier than the second time and the observation value at a fourth time that is earlier than the second time and later than the third time using a Gaussian Mixture Model, when a state transition occurs from the viewing direction at the third time to the viewing direction at the fourth time, and updates the transition probability based on the probability density function. Consequently, for example, it is possible to increase the accuracy of the viewing direction estimation that uses the transition probability.

In the viewing direction estimation device of the embodiments, the update unit updates the transition probability based on the probability density function, every time the viewing direction is estimated. Consequently, for example, it is possible to further increase the accuracy of the viewing direction estimation.

In the viewing direction estimation device of the embodiments, the observation value is an angle of the face of the driver of the vehicle, an angle of the visual line of the driver of the vehicle, a moving speed of the face of the driver of the vehicle, or an eye opening degree of the driver of the vehicle. Consequently, for example, the estimation result of the viewing direction can follow the quick change in the viewing direction.

In the viewing direction estimation device of the embodiments, the viewing direction is a left-hand side view in which the driver is viewing left while seated on a seat of the vehicle, front in which the driver is viewing front while seated on the seat of the vehicle, a right-hand side view in which the driver is viewing right while seated on the seat of the vehicle, or a downward side view in which the driver is viewing downward while seated on the seat of the vehicle. Consequently, for example, the estimation result of the viewing direction can follow the quick change in the viewing direction to the left-hand side view, the front, the right-hand side view, or the downward side view.

### BRIEF DESCRIPTION OF DRAWINGS

FIG. 1 is a perspective view illustrating a state when a part of a vehicle chamber of a vehicle according to the present embodiment is seen through;

FIG. 2 is a diagram illustrating an example of how an image pickup device included in the vehicle according to the present embodiment is disposed;

FIG. 3 is a block diagram illustrating an example of a configuration of a viewing direction estimation system included in the vehicle according to the present embodiment;

FIG. 4 is a block diagram illustrating a functional configuration of an ECU included in the vehicle according to the present embodiment;

FIG. 5 is an explanatory diagram of an example of a viewing direction estimated by the ECU included in the vehicle according to the present embodiment;

FIG. 6 is an explanatory diagram of an example of a transition probability stored by the ECU included in the vehicle according to the present embodiment;

FIG. 7A is a diagram illustrating an example of a distribution diagram of a difference between the visual line angles calculated by the ECU included in the vehicle according to the present embodiment;

FIG. 7B is a diagram illustrating an example of a distribution diagram of a difference between the visual line angles calculated by the ECU included in the vehicle according to the present embodiment;

FIG. 7C is a diagram illustrating an example of a distribution diagram of a difference between the visual line angles calculated by the ECU included in the vehicle according to the present embodiment;

FIG. 7D is a diagram illustrating an example of a distribution diagram of a difference between the visual line angles calculated by the ECU included in the vehicle according to the present embodiment;

FIG. 7E is a diagram illustrating an example of a distribution diagram of a difference between the visual line angles calculated by the ECU included in the vehicle according to the present embodiment;

FIG. 7F is a diagram illustrating an example of a distribution diagram of a difference between the visual line angles calculated by the ECU included in the vehicle according to the present embodiment;

FIG. 7G is a diagram illustrating an example of a distribution diagram of a difference between the visual line angles calculated by the ECU included in the vehicle according to the present embodiment;

FIG. 7H is a diagram illustrating an example of a distribution diagram of a difference between the visual line angles calculated by the ECU included in the vehicle according to the present embodiment;

FIG. 7I is a diagram illustrating an example of a distribution diagram of a difference between the visual line angles calculated by the ECU included in the vehicle according to the present embodiment;

FIG. 8 is an explanatory diagram of an example of a calculation method of a Gaussian mixture distribution in the ECU included in the vehicle according to the present embodiment;

FIG. 9 is a flowchart illustrating an example of a flow of a calculation process of a state probability by the ECU included in the vehicle according to the present embodiment;

FIG. 10 is an explanatory diagram of an example of a calculation process of the state probability by the ECU included in the vehicle according to the present embodiment;

FIG. 11 is a diagram illustrating an example of calculation results of the state probability by the ECU included in the vehicle according to the present embodiment; and

FIG. 12 is a diagram illustrating an example of a corresponding relation between the precision and recall of the viewing direction by the ECU included in the vehicle according to the present embodiment.

### DESCRIPTION OF EMBODIMENTS

Hereinafter, an example of mounting a viewing direction estimation device of the present embodiment on a vehicle will be described with reference to the accompanying drawings.

In the present embodiment, for example, a vehicle 1 may be an automobile that uses an internal combustion engine (engine, not illustrated) as a drive source (internal combustion engine automobile), an automobile that uses an electric motor (motor, not illustrated) as a drive source (electric automobile, fuel-cell automobile, and the like), or an automobile that uses the internal combustion engine and the electric motor as a drive source (hybrid automobile). Moreover, various transmissions may be mounted on the vehicle 1, and various devices (system, parts, and the like) required for driving the internal combustion engine and the electric motor may be mounted on the vehicle 1. Furthermore, the system, the number, the layout, and the like of the device relating to driving wheels 3 of the vehicle 1 may be set in various ways.

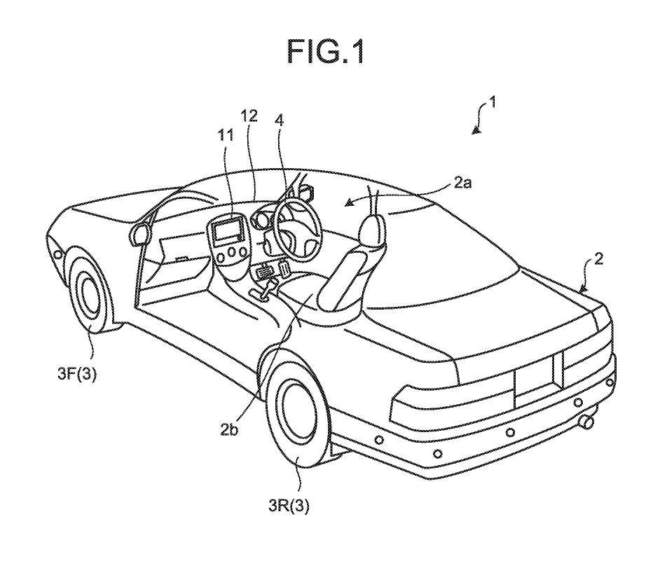

As illustrated in FIG. 1, a vehicle body 2 of the vehicle 1 includes a vehicle chamber 2a in which a driver (not illustrated) gets on. In the vehicle chamber 2a, a steering wheel unit 4 and the like are provided so as to face a seat 2b of the driver serving as a passenger. In the present embodiment, for example, the steering wheel unit 4 is a steering wheel projected from a dashboard (instrument panel) 12.

Moreover, as illustrated in FIG. 1, in the present embodiment, for example, the vehicle 1 is a four wheel car (four-wheeled automobile), and includes two left and right front wheels 3F and two left and right rear wheels 3R. Furthermore, in the present embodiment, the four wheels 3 are all configured to be steered (steerable).

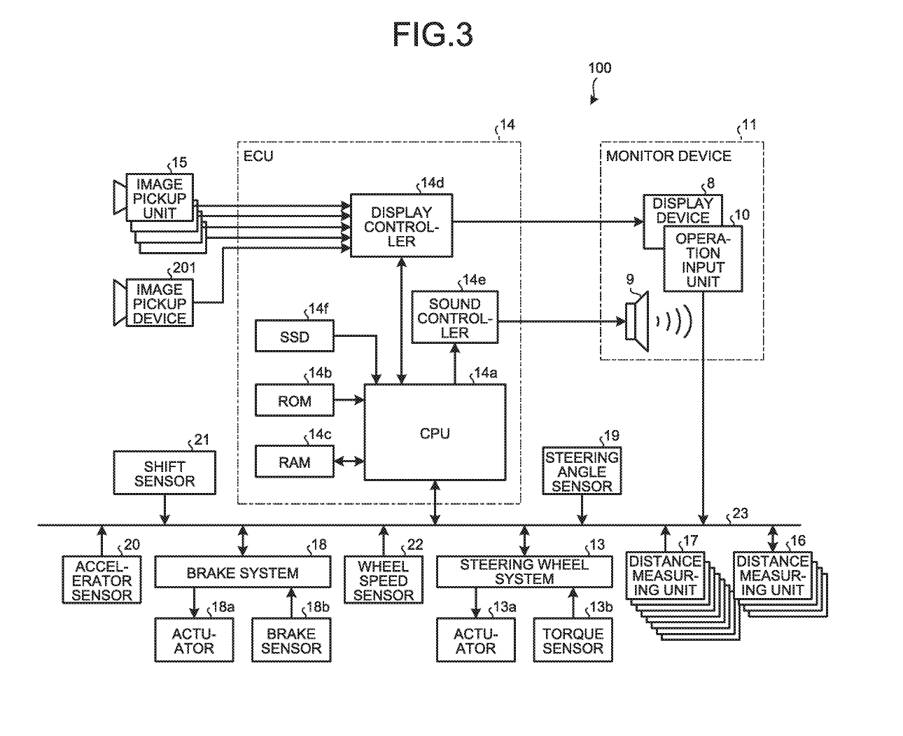

Still furthermore, a monitor device 11 is provided at the center portion of the dashboard 12 in the vehicle chamber 2a in the vehicle width direction, in other words, the left and right direction. The monitor device 11 includes a display device 8 (see FIG. 3) and a sound output device 9 (see FIG. 3). For example, the display device 8 is a liquid crystal display (LCD), an organic electroluminescent display (OELD), and the like. For example, the sound output device 9 is a speaker. For example, the display device 8 is covered by a transparent operation input unit 10 (see FIG. 3) such as a touch panel. The passenger can view an image displayed on a display screen of the display device 8 via the operation input unit 10. The passenger can also execute an input operation by operating the operation input unit 10 by touching, pushing, or moving the operation input unit 10 with a hand, a finger, or the like at a position corresponding to the image displayed on the display screen of the display device 8.

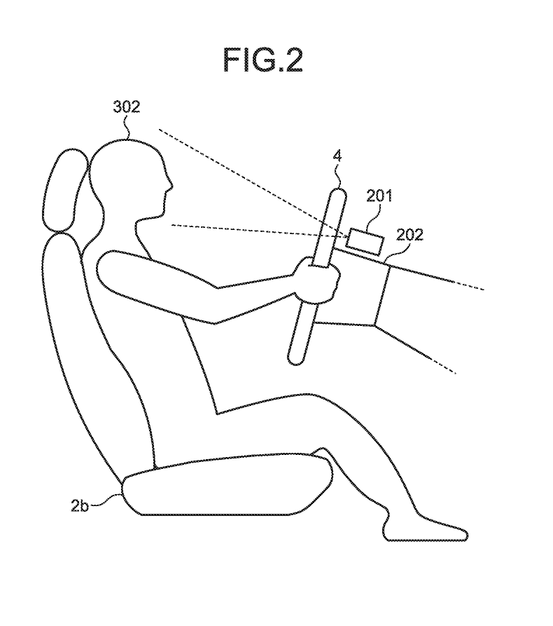

Still furthermore, as illustrated in FIG. 2, an image pickup device 201 is mounted on a steering wheel column 202. For example, the image pickup device 201 is a charge coupled device (CCD) camera and the like. The viewing angle and the posture of the image pickup device 201 are adjusted so that the face of a driver 302 who is seated on the seat 2b is placed in the center of the viewing field. The image pickup device 201 sequentially picks up images of the face of the driver 302, and sequentially outputs image data on the image obtained by the image pickup.

Next, with reference to FIG. 3, a viewing direction estimation system included in the vehicle according to the present embodiment will be described. FIG. 3 is a block diagram illustrating an example of a configuration of a viewing direction estimation system included in the vehicle according to the present embodiment. As illustrated in FIG. 3, in a viewing direction estimation system 100, an engine control unit (ECU) 14, a monitor device 11, a steering wheel system 13, distance measuring units 16 and 17, a brake system 18, a steering angle sensor 19, an accelerator sensor 20, a shift sensor 21, a wheel speed sensor 22, and the like are electrically connected via an in-vehicle network 23 serving as an electric communication line. For example, the in-vehicle network 23 is configured as a controller area network (CAN). The ECU 14 controls the steering wheel system 13, the brake system 18, and the like by sending a control signal through the in-vehicle network 23, and drives actuators 13a and 18a. Moreover, the ECU 14 can receive detection results of a torque sensor 13b, a brake sensor 18b, the steering angle sensor 19, the distance measuring units 16 and 17, the accelerator sensor 20, the shift sensor 21, the wheel speed sensor 22, and the like; and an operation signal of the operation input unit and the like; via the in-vehicle network 23. In this example, the ECU 14 is an example of the viewing direction estimation device.

For example, the ECU 14 includes a central processing unit (CPU) 14a, a read only memory (ROM) 14b, a random access memory (RAM) 14c, a display controller 14d, a sound controller 14e, a solid state drive (SSD; flash memory) 14f, and the like. The CPU 14a controls the entire vehicle 1. The CPU 14a can read out a program installed and stored in a nonvolatile storage device such as the ROM 14b, and execute arithmetic processing according to the program. The RAM 14c temporarily stores therein various types of data used in the operation performed by the CPU 14a. Moreover, the display controller 14d mainly executes image processing using image data obtained from an image picked up by an image pickup unit 15 provided so as to be able to pick up the outside image of the vehicle 1, combines image data displayed on the display device, and the like, in the arithmetic processing performed by the ECU 14. Furthermore, the sound controller 14e mainly executes a process on the sound data output by the sound output device, in the arithmetic processing performed by the ECU 14. The SSD 14f is a rewritable nonvolatile storage, and can store data even if the power of the ECU 14 is turned OFF. The CPU 14a, the ROM 14b, the RAM 14c, and the like may be accumulated in the same package. Still furthermore, in the ECU 14, another logical operation processor such as a digital signal processor (DSP) and a logical circuit may be used instead of the CPU 14a. Still furthermore, a hard disk drive (HDD) may be provided instead of the SSD 14f, and the SSD 14f and the HDD may be separately provided from the ECU 14. The configurations, arrangements, electric connection mode, and the like of the various sensors and the actuators described above are merely examples, and may be set (changed) in various manners.

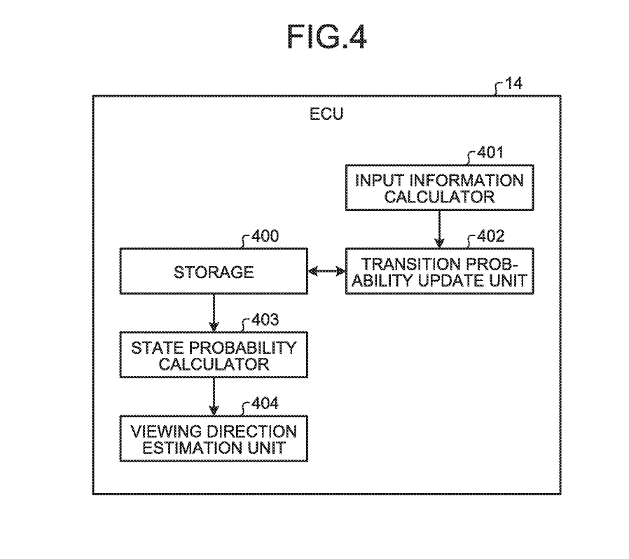

FIG. 4 is a block diagram illustrating a functional configuration of the ECU included in the vehicle according to the present embodiment. As illustrated in FIG. 4, the ECU 14 mainly includes a storage 400, an input information calculator 401, a transition probability update unit 402, a state probability calculator 403, and a viewing direction estimation unit 404. The input information calculator 401, the transition probability update unit 402, the state probability calculator 403, and the viewing direction estimation unit 404 illustrated in FIG. 4 are implemented when the CPU 14a in the ECU 14 executes the program stored in the ROM 14b. These configurations may be implemented by hardware. The storage 400 is provided by a storage medium such as the RAM 14c and the SSD 14f. In the present embodiment, as will be described below, the storage 400 stores therein a transition probability between the viewing directions of the driver of the vehicle 1, input information serving as an observation value relating to the face or visual line of the driver of the vehicle 1, and the like.

More specifically, the storage 400 stores therein an observation value (what is called learning data) at the time t−2, and an observation value (what is called learning data) at the time t−1 that is later than the time t−2. The storage 400 also stores therein a transition probability aᵢⱼ from the viewing direction of the driver of the vehicle 1 at the time t−1 to the viewing direction at the time t that is later than the time t−1. In this example, the viewing direction is an unobservable internal state of the Hidden Markov Model. Moreover, i is a value (hereinafter, referred to as an output value) indicating the viewing direction at the time t−1. j is an output value indicating the viewing direction at the time t. The ECU 14 calculates a state probability αₜ (j) shifting from the viewing directions at the time t−1 to the viewing directions at the time t, according to the transition probability aᵢⱼ stored in the storage 400 using the Hidden Markov Model. The ECU 14 then estimates the viewing direction at the time after the time t on the basis of the state probability αₜ (j).

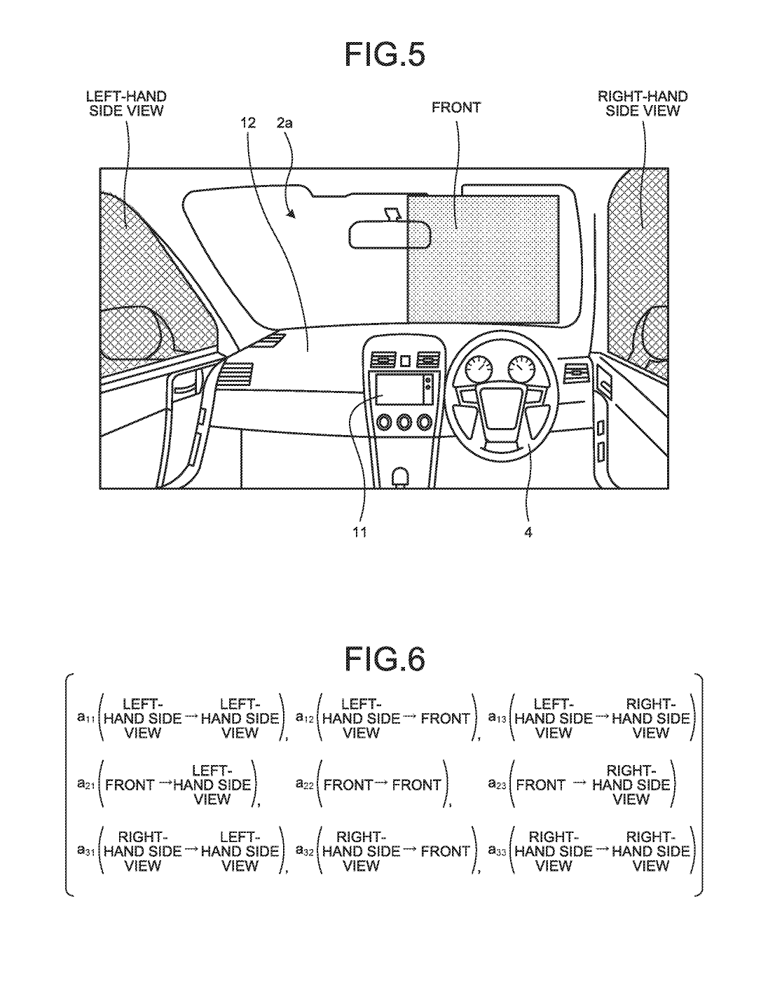

FIG. 5 is an explanatory diagram of an example of a viewing direction estimated by the ECU included in the vehicle according to the present embodiment. FIG. 6 is an explanatory diagram of an example of a transition probability stored by the ECU included in the vehicle according to the present embodiment. In the present embodiment, as illustrated in FIG. 5, the viewing direction estimated by the ECU 14 includes a left-hand side view (output value 1) in which the driver is viewing left while seated on the seat 2b, front (output value 2) in which the driver is viewing front while seated on the seat 2b, and a right-hand side view (output value 3) in which the driver is viewing right while seated on the seat 2b. Consequently, in the present embodiment, there is the transition probability aᵢⱼ for each of the three output values the viewing direction may take at the time after the time t, for each of the three output values the viewing direction may take at the time t−1. Thus, as illustrated in FIG. 6, the transition probability aᵢⱼ is represented by a Markov matrix of 3×3. In the present embodiment, the viewing directions estimated by the ECU 14 are the left-hand side view, the front, and the right-hand side view. However, it is not limited thereto. For example, the viewing direction estimated by the ECU 14 may also be a downward side view in which the driver of the vehicle 1 is viewing downward while seated on the seat 2b, and an upward side view in which the driver of the vehicle 1 is viewing upward while seated on the seat 2b.

The input information calculator 401 calculates an observation value relating to the face or visual line of the driver of the vehicle 1. In the present embodiment, the input information calculator 401 calculates the angle of the face of the driver of the vehicle 1 (hereinafter, referred to as a face angle), the angle of the visual line of the driver of the vehicle 1 (hereinafter, referred to as a visual line angle), or the moving speed of the face of the driver of the vehicle 1 as the observation value. In this example, the face angle is the angle in which the face of the driver of the vehicle 1 is rotated in the horizontal direction, on the basis of the face angle (0°) when the driver of the vehicle 1 is viewing front. Moreover, the visual line angle is the angle in which the visual line of the driver of the vehicle 1 is moved in the horizontal direction, on the basis of the visual line angle (0°) when the driver of the vehicle 1 is viewing front. The input information calculator 401 transmits the input information indicating the calculated observation value to the transition probability update unit 402.

More specifically, the storage medium such as the SSD 14f stores therein a three-dimensional face model. The three-dimensional face model is a statistical face shape model, and includes a three-dimensional face shape of an average research subject, and positions of facial parts such as eyes, mouth, and nose of the research subject. For example, a constrained local model (CLM), an active appearance model (AAM), an active shape model (ASM) may be used as the three-dimensional face model. However, it is not limited thereto. The input information calculator 401 calculates the face angle, the visual line angle, or the moving speed, while tracking the face image included in the picked up image data obtained from an image picked up by the image pickup device 201, using the three-dimensional face model stored in the storage medium such as the SSD 14f. In the present embodiment, the input information calculator 401 calculates the face angle, the visual line angle, or the moving speed as an example of the observation value. However, it is not limited thereto. The input information calculator 401 may calculate any observation value as long as it relates to the face or the visual line of the driver of the vehicle 1. For example, the input information calculator 401 may calculate an eye opening degree of the driver of the vehicle 1 as the observation value.

The transition probability update unit 402 functions as a receiver that receives input information from the input information calculator 401. The transition probability update unit 402 updates the transition probability aᵢⱼ stored in the storage 400, on the basis of the observation value calculated at the time earlier than the time t by the input information calculator 401 (in the present embodiment, the observation value calculated at the time t−2 and the observation value calculated at the time t−1), and the observation value calculated at the time t by the input information calculator 401. In the present embodiment, the transition probability update unit 402 obtains a probability density function of a difference xₜ between the observation value calculated at the time t−2 and the observation value calculated at the time t−1, when a state transition occurs from the viewing direction at the time t−2 in the time earlier than the time t to the viewing direction at the time t−1 in the time earlier than the time t, by a Gaussian mixture distribution. The transition probability update unit 402 then updates the transition probability aᵢⱼ on the basis of the calculated probability density function. Consequently, even when noise is included in the observation value, it is possible to reduce the influence of the noise on the transition probability aᵢⱼ. Thus, it is possible to increase the accuracy of the viewing direction estimation that uses the transition probability aᵢⱼ.

In the present embodiment, the transition probability update unit 402 updates the transition probability aᵢⱼ on the basis of the probability density function, every time the viewing direction is estimated. Consequently, the viewing direction is estimated using the transition probability aᵢⱼ for estimating the viewing direction in which the habit of the driver or the like is reflected. As a result, it is possible to increase the accuracy of the viewing direction estimation. Moreover, in the present embodiment, it is assumed that the transition probability update unit 402 calculates the probability density function in advance, prior to updating the transition probability aᵢⱼ. Consequently, it is possible to estimate the viewing direction without waiting for the time required for calculating the probability density function while estimating the viewing direction. As a result, it is possible to reduce the time required for estimating the viewing direction.

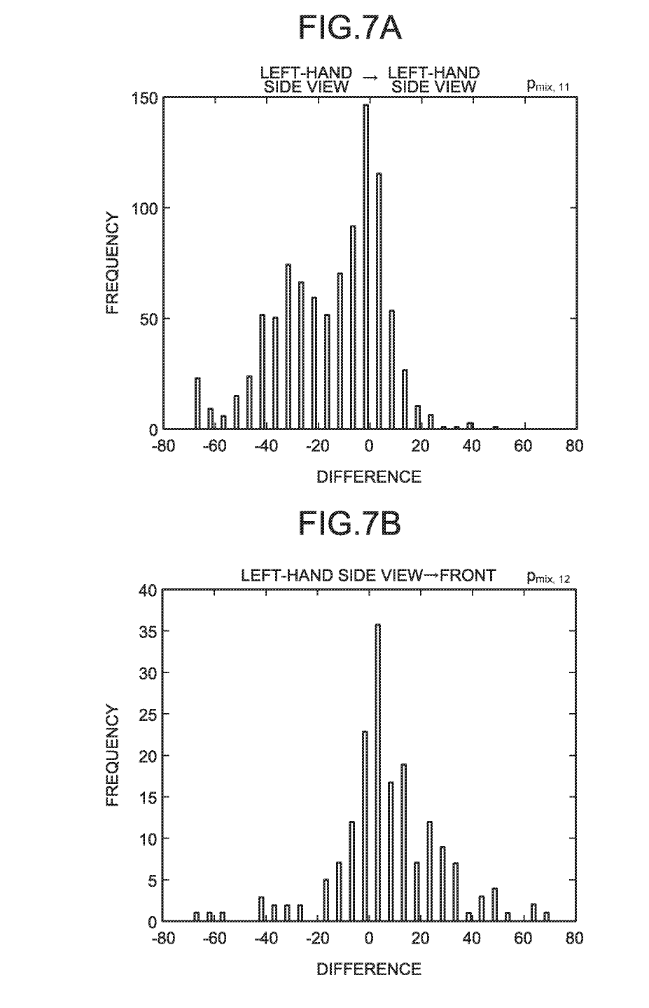

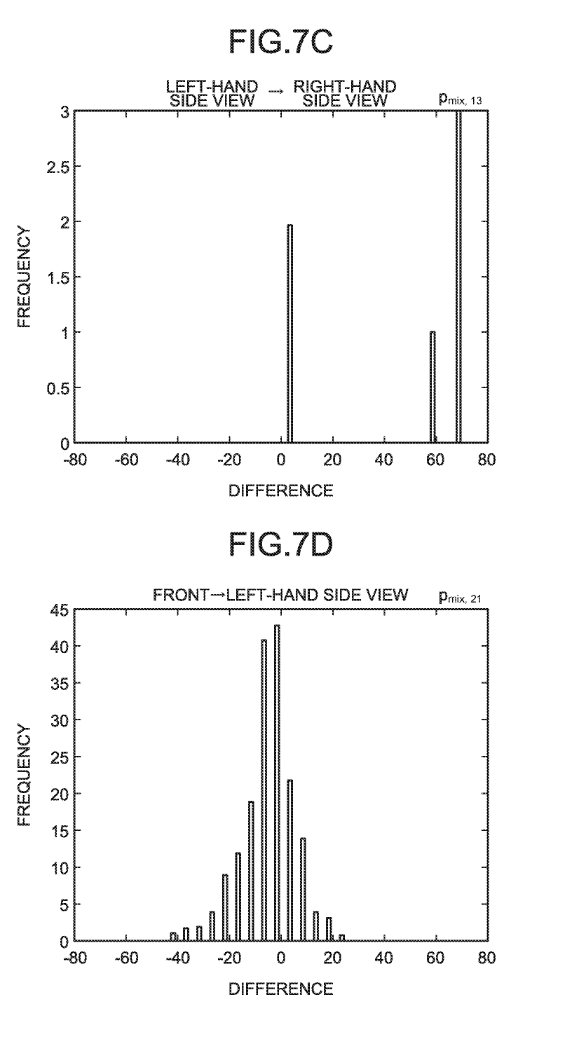

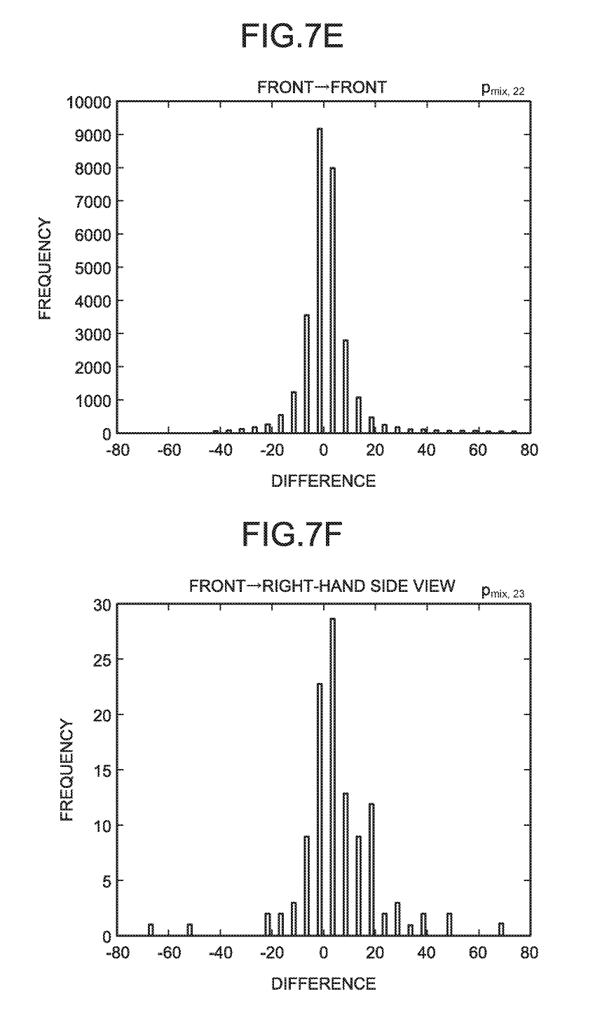

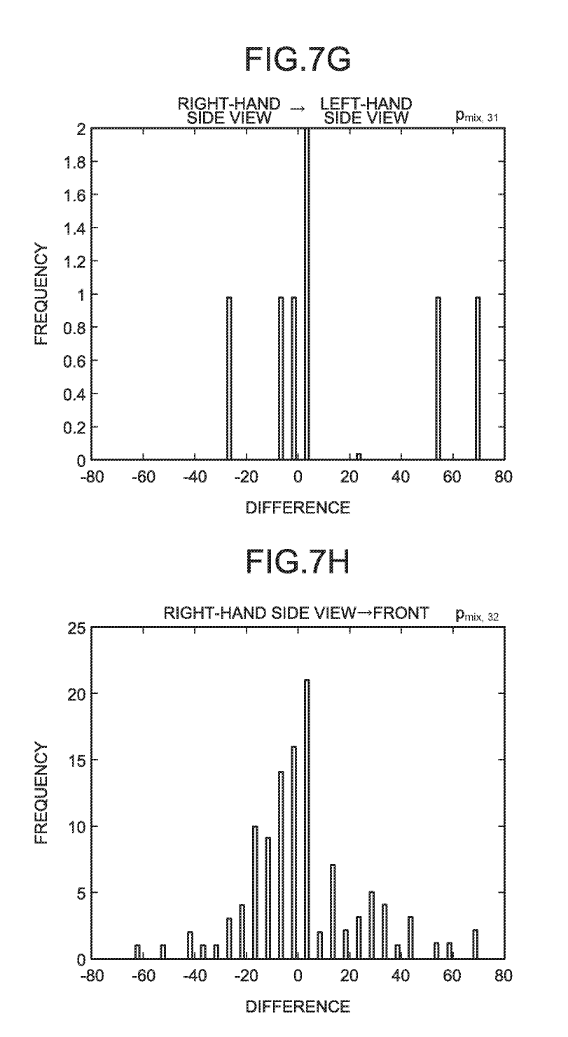

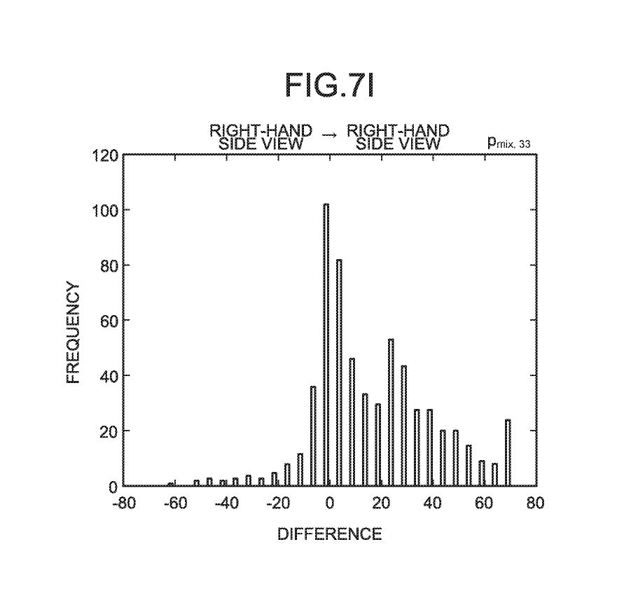

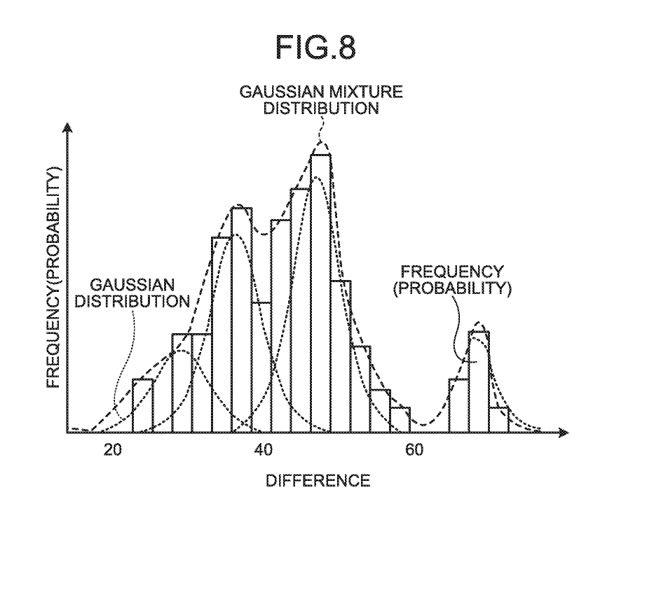

A method of updating the transition probability aᵢⱼ will now be described with reference to FIGS. 7A to 7I, and FIG. 8. In the following explanation, a method of updating the transition probability aᵢⱼ using the visual line angle calculated by the input information calculator 401 as the observation value will be described. The same applies when the transition probability aᵢⱼ is updated using the face angle or moving speed as the observation value. FIGS. 7A to 7I are diagrams each illustrating an example of a distribution diagram of frequency of each difference generated between the visual line angles calculated by the ECU included in the vehicle according to the present embodiment. In FIGS. 7A to 7I, the horizontal axis represents the difference xₜ generated between the visual line angle ωₜ₋₂ calculated at the time t−2 and the visual line angle ωₜ₋₁ calculated at the time t−1. In FIGS. 7A to 7I, the vertical axis represents the frequency of the difference xₜ. FIG. 8 is an explanatory diagram of an example of a calculation method of the Gaussian mixture distribution in the ECU included in the vehicle according to the present embodiment.

In the present embodiment, as illustrated in FIGS. 7A to 7I, the transition probability update unit 402 obtains the distribution diagram of each difference xₜ generated between the visual line angle ωₜ₋₂ calculated at the time t−2 and the visual line angle ωₜ₋₁ calculated at the time t−1, when a transition occurs from the viewing direction at the time t−2 to the viewing directions at the time t−1. According to the distribution diagram, the frequency at which the difference xₜ occurs differs for each type of the state transition from the viewing direction at the time t−2 to the viewing direction at the time t−1. For example, as illustrated in FIG. 7A, when the viewing direction at the time t−2 is the left-hand side view and the viewing direction at the time t−1 is the left-hand side view, the frequency at which the difference xₜ=−40° occurs is “50”. Alternatively, as illustrated in FIG. 7B, when the viewing direction at the time t−2 is the left-hand side view and the viewing direction at the time t−1 is the front, the frequency at which the difference xₜ=−40° occurs is “3”. Moreover, as illustrated in FIG. 7C, when the viewing direction at the time t−2 is the left-hand side view and the viewing direction at the time t−1 is the right-hand side view, the frequency at which the difference xₜ=−40° occurs is “0”.

Thus, the transition probability update unit 402 calculates the probability density function of the difference xₜ between the visual line angle ωₜ₋₂ at the time t−2 and the visual line angle ωₜ₋₁ at the time t−1, for each type of the state transition from the viewing direction at the time t−2 to the viewing direction at the time t−1, when the state transition of the type occurs, using the Gaussian Mixture Model. More specifically, the transition probability update unit 402 obtains distribution of frequency (probability) (hereinafter, referred to as frequency distribution) of each difference xₜ between the visual line angle ωₜ₋₂ at the time t−2 and the visual line angle ωₜ₋₁ at the time t−1, when a state transition occurs from the viewing direction at the time t−2 to the viewing direction at the time t−1. The transition probability update unit 402 then calculates the probability density function of the obtained frequency distribution according to the Gaussian Mixture Model.

More specifically, as illustrated in FIG. 8, the transition probability update unit 402 obtains the Gaussian distribution of the peaks in the frequency distribution. Then, as illustrated in FIG. 8, the transition probability update unit 402 calculates the function indicating the Gaussian mixture distribution in which the Gaussian distribution of the peaks in the frequency distribution is combined by the Gaussian Mixture Model, as the probability density function.

For example, according to the following expression (1), the transition probability update unit 402 calculates a probability density function P_{mix,ij} (xₜ, θ). In the expression (1), pᵣ is a mixture ratio, h(xₜ, ωₜ) is a Gaussian distribution of each peak in the frequency distribution, R is the number of Gaussian distributions to be superposed, and θ is a predetermined parameter {(pᵣ, ωₜ):1≤r≤R}.

$${p}_{mix , ij} ( {x}_{t} , θ ) = {\sum }_{r = 1}^{R} {p}_{r} \times h ( {x}_{t} , {ω}_{t} ) \qquad ( 1 )$$

The transition probability update unit 402 then updates the transition probability aᵢⱼ on the basis of the probability density function. In the present embodiment, the transition probability update unit 402 selects the probability density function p_{mix,ij} (xₜ, θ) of the state transition indicated by the transition probability aᵢⱼ to be updated. Next, the transition probability update unit 402 updates the transition probability aᵢⱼ to be updated, by using the probability density at the difference xₜ between the visual line angle ωₜ₋₁ at the time t−1 and the visual line angle ωₜ at the time t, in the probability density indicated by the selected probability density function p_{mix,ij} (xₜ, θ).

For example, the transition probability update unit 402 calculates a transition probability a_{t,ij} (xₜ) updated from the transition probability aᵢⱼ, according to the following expression (2) or (3). More specifically, when the transition probability aᵢⱼ to be updated is a fixed value, the transition probability update unit 402 calculates the updated transition probability a_{t,ij} (xₜ) according to the following expression (2). Alternatively, when the transition probability aᵢⱼ to be updated is the last updated transition probability, the transition probability update unit 402 calculates the updated transition probability a_{t,ij} (xₜ) according to the following expression (3). In this example, the last updated transition probability is a transition probability a_{t-1,ij} (xₜ₋₁) used for calculating the state probability shifting to the viewing direction at the time t−1.

a_{t,ij}(xₜ)=aᵢⱼ×p_{mix,ij}(xₜ,θ) (2)

a_{t,ij}(xₜ)=a_{t-1,ij}(xₜ₋₁)×p_{mix,ij}(xₜ,θ) (3)

Returning to FIG. 4, the state probability calculator 403 calculates the state probability αₜ(j) shifting from the viewing directions at the time t−1 to the viewing directions at the time t, according to the updated transition probability a_{t,ij} (xₜ), using the Hidden Markov Model. In the present embodiment, as illustrated in the following expression (4), the state probability calculator 403 calculates the state probability αₜ (j) according to the transition probability a_{t,ij} (xₜ) updated by the transition probability update unit 402. In the expression (4), αₜ₋₁ (i) is the state probability of the viewing directions at the time t−1, and b(ωₜ,xₜ) is the output probability when the observation value ωₜ in the viewing directions at the time t is calculated.

$${α}_{t , ij} ( j ) = {\sum }_{i = 1}^{n} ( {α}_{t - 1} ( i ) \times {a}_{t , ij} ( {x}_{t} ) ) \times b ( {ω}_{t} , {x}_{t} ) \qquad ( 4 )$$

The viewing direction estimation unit 404 estimates the viewing direction at the time t or the time t+1 on the basis of the state probability αₜ (j) calculated by the state probability calculator 403. Consequently, it is possible to easily detect the change in the viewing direction when the observation value is changed, and follow the quick change in the viewing direction. In the present embodiment, the viewing direction estimation unit 404 estimates the viewing direction in which the state probability αₜ(j) at the time t that is calculated on the basis of the state probability αₜ₋₁ (i) of the viewing directions (left-hand side view, front, and right-hand side view) estimated at the time t−1 is the highest, as the viewing direction at the time t. Moreover, the viewing direction estimation unit 404 estimates the viewing direction in which the state probability αₜ₊₁ (j) at the time t+1 calculated on the basis of the state probability αₜ (i) of the viewing directions (left-hand side view, front, and right-hand side view) estimated at the time t is the highest, as the viewing direction at the time t+1.

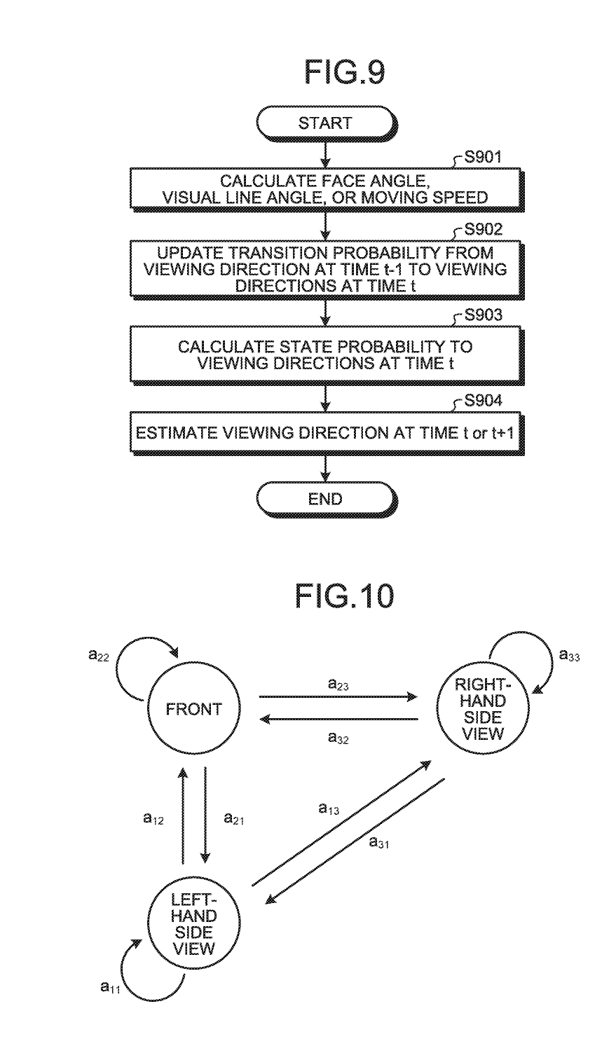

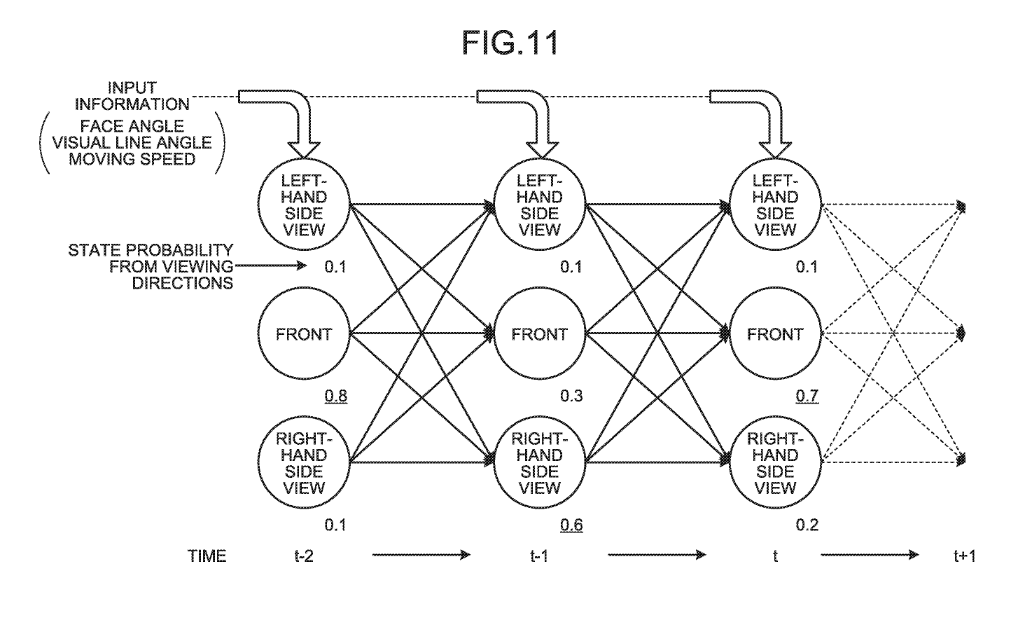

Next, a flow of the calculation process of the state probability αₜ (j) by the ECU 14 according to the present embodiment will be described with reference to FIGS. 9 to 11. FIG. 9 is a flowchart illustrating an example of a flow of a calculation process of a state probability by the ECU included in the vehicle according to the present embodiment. FIG. 10 is an explanatory diagram of an example of a calculation process of the state probability by the ECU included in the vehicle according to the present embodiment. FIG. 11 is a diagram illustrating an example of calculation results of the state probability by the ECU included in the vehicle according to the present embodiment.

In the present embodiment, the input information calculator 401 calculates the face angle, the visual line angle, or the moving speed as the observation value (step S901). More specifically, the input information calculator 401 fits the image data obtained from an image picked up by the image pickup device 201 with the three-dimensional facial structure data that configures the three-dimensional face model. In other words, the input information calculator 401 calculates the observation value by performing model fitting and model tracking. In the present embodiment, the image pickup device 201 repeatedly picks up the image of the driver of the vehicle 1 at every preset time interval. Consequently, the input information calculator 401 performs model fitting and model tracking every time the image pickup device 201 picks up an image.

In the model fitting, an average face model in the three-dimensional face model serving as the statistical face shape model is used as an initial state. The model fitting generates a three-dimensional face model that resembles the face of the driver picked up by the image pickup device 201, by placing the feature points of the model on the portions of the face in the picked up image. In the model tracking, the face generated by the model fitting is continuously fitted to the three-dimensional model so as to match with the face in the image data of the driver that is picked up periodically. The input information calculator 401 calculates the observation value on the basis of the three-dimensional model obtained by the model tracking.

Next, as illustrated in FIG. 10, the transition probability update unit 402 updates the transition probability a_{t,ij} (xₜ) from the viewing direction at the time t−1 to the viewing directions at the time t, on the basis of the difference xₜ between the observation value calculated at the time t−2 and the observation value calculated at the time t−1 by the input information calculator 401, and the observation value calculated at the time t by the input information calculator 401 (step S902). Moreover, as illustrated in FIG. 11, the state probability calculator 403 calculates the state probability αₜ (j) shifting from the viewing direction at the time t−1 to the viewing directions at the time t according to the updated transition probability a_{t,ij} (xₜ) using the Hidden Markov Model (step S903). The viewing direction estimation unit 404 then estimates the viewing direction at the time t or the time t+1, on the basis of the calculated state probability aₜ (j) (step S904).

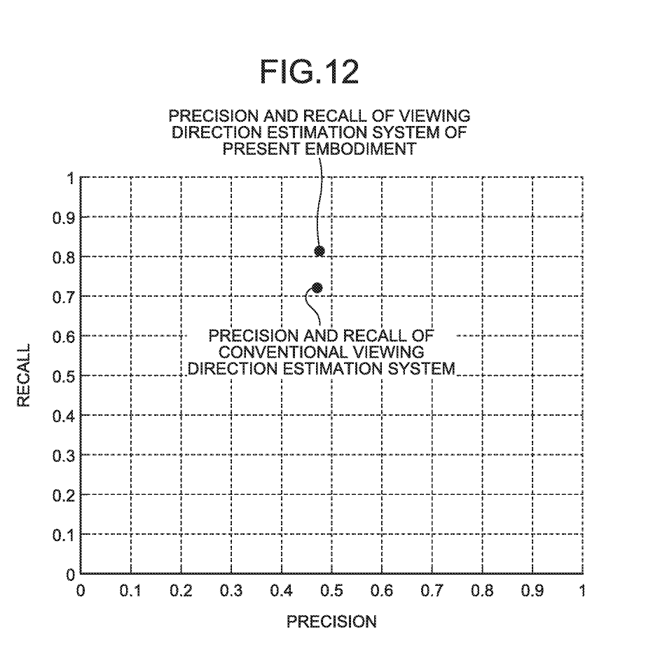

FIG. 12 is a diagram illustrating an example of a corresponding relation between the precision and recall of the viewing direction by the ECU included in the vehicle according to the present embodiment. In FIG. 12, the vertical axis represents precision and the horizontal axis represents recall. In this example, the precision is a proportion of correctly estimated viewing direction (for example, right-hand side view), in the viewing direction (right-hand side view) estimated by the viewing direction estimation system 100. The recall is a proportion of correctly estimated viewing direction (for example, right-hand side view) by the viewing direction estimation system 100, in the actual viewing direction (right-hand side view) of the driver of the vehicle 1. As illustrated in FIG. 12, the precision and recall in the estimation process of the viewing direction by the ECU 14 according to the present embodiment are both higher than the precision and recall in the estimation process of the viewing direction carried out by the conventional viewing direction estimation system. In the present embodiment, the transition probability update unit 402 obtains the Gaussian mixture distribution again every time the viewing direction is estimated. Consequently, it is possible to improve the precision and recall of the viewing direction to be estimated.

In this manner, with the viewing direction estimation system 100 according to the present embodiment, it is possible to make the estimation result of the viewing direction follow the quick change in the viewing direction, by dynamically changing the transition probability aᵢⱼ relative to the state change in the viewing direction occurring due to the change in the observation value. Consequently, it is possible to improve the precision and recall in the estimation process of the viewing direction.

The program executed by the ECU 14 in the present embodiment is provided by being incorporated in advance in the ROM 14b and the like. However, the program executed by the ECU 14 of the present embodiment may also be provided by being recorded in a computer-readable recording medium such as a compact disc-read only memory (CD-ROM), a flexible disk (FD), a compact disc-recordable (CD-R), a digital versatile disc (DVD), and the like, in an installable or executable file format.

Moreover, the program executed by the ECU 14 of the present embodiment may be stored in a computer connected to a network such as the Internet, and provided by downloading the program via the network. Furthermore, the program executed by the ECU 14 of the present embodiment may be provided or distributed via a network such as the Internet.

The program executed by ECU 14 of the present embodiment has a modular configuration including the units described above (input information calculator 401, transition probability update unit 402, state probability calculator 403, and viewing direction estimation unit 404). As actual hardware, when the CPU 14a reads out the program from the ROM 14b described above and executes the program, the units described above are loaded on the main storage device, thereby generating the input information calculator 401, the transition probability update unit 402, the state probability calculator 403, and the viewing direction estimation unit 404 on the main storage device.

While some embodiments of the present invention have been described, these embodiments are merely examples, and are not intended to limit the scope of the invention. These embodiments may be implemented in various other forms, and various omissions, substitutions, and modifications may be made without departing from the scope and spirit of the invention. These embodiments are included in the scope and spirit of the invention, and are included in the invention described in the claims and their equivalents.

1. A viewing direction estimation device, comprising:
a storage that stores therein a transition probability between viewing directions of a driver of a vehicle; and
a processor configured to:
receive an observation value relating to a face or a visual line of the driver of the vehicle;
update the transition probability from the viewing direction at a first time to the viewing direction at a second time that is later than the first time, based on the observation value at the first time and the observation value at the second time;
calculate a state probability shifting from the viewing direction at the first time to the viewing direction at the second time according to the transition probability being updated, using a Hidden Markov Model; and
estimate the viewing direction at a time after the second time, based on the state probability being calculated.

2. The viewing direction estimation device according to claim 1, wherein the processor
calculates a probability density function of a difference between the observation value at a third time that is earlier than the second time and the observation value at a fourth time that is earlier than the second time and later than the third time using a Gaussian Mixture Model, when a state transition occurs from the viewing direction at the third time to the viewing direction at the fourth time, and
updates the transition probability based on the probability density function.

3. The viewing direction estimation device according to claim 2, wherein the processor updates the transition probability based on the probability density function, every time the viewing direction is estimated.

4. The viewing direction estimation device according to claim 1, wherein the observation value is an angle of the face of the driver of the vehicle, an angle of the visual line of the driver of the vehicle, a moving speed of the face of the driver of the vehicle, or an eye opening degree of the driver of the vehicle.

5. The viewing direction estimation device according to claim 1, wherein the viewing direction is a left-hand side view in which the driver is viewing left while seated on a seat of the vehicle, front in which the driver is viewing front while seated on the seat of the vehicle, a right-hand side view in which the driver is viewing right while seated on the seat of the vehicle, or a downward side view in which the driver is viewing downward while seated on the seat of the vehicle.
